(19) United States
(12) Patent Application Publication
(10) Pub. No.: US 2026/0172512 A1
(43) Pub. Date: Jun. 18, 2026

(54) INFORMATION PROCESSING APPARATUS, IMAGE READING APPARATUS, AND NON-TRANSITORY RECORDING MEDIUM

(71) Applicant: PFU Limited, ISHIKAWA (JP)

(72) Inventors: Daiki KAWAI, ISHIKAWA (JP); Tomoaki WADA, ISHIKAWA (JP)

(21) Appl. No.: 19/416,418

(22) Filed: Dec. 11, 2025

(30) Foreign Application Priority Data
Dec. 17, 2024 (JP) 2024-220991

(51) Int. Cl. H04N 1/00

(52) U.S. Cl. CPC H04N 1/00517; H04N 1/00413; H04N 1/0097

(57) ABSTRACT

An information processing apparatus includes circuitry to receive a selection of an integration destination for imaging data from among a plurality of integration destination candidates, using settings information that includes imaging settings and an integration destination setting, determine whether a usage frequency of the integration destination meets a predetermined condition, create additional settings information that includes the integration destination specified in the integration destination setting when a usage frequency of the integration destination meets a predetermined condition, and display, on a display, the additional settings information as available.

### CROSS-REFERENCE TO RELATED APPLICATIONS

This patent application is based on and claims priority pursuant to 35 U.S.C. § 119(a) to Japanese Patent Application No. 2024-220991, filed on Dec. 17, 2024, in the Japan Patent Office, the entire disclosure of which is hereby incorporated by reference herein.

### BACKGROUND

The present disclosure relates to an information processing apparatus, an image reading apparatus, and a non-transitory recording medium.

A technique for selecting an integration destination for image data read from a document by a scanner (read image data) has been known. Selecting an integration destination for read image data includes a user operation for integrating the read image data with an integration destination application. In other words, selecting an integration destination for read image data may reflect the intended use of the read image data, which is image data read from a document by a scanner.

The user selects an integration destination for image data read from a document by a scanner by the following two methods using settings information (such as a profile) that includes document reading settings and a setting for an integration destination for read image data. In the following description, the setting for an integration destination may be referred to as an integration destination setting.

The first method involves creating settings information that includes an integration destination application specified in the integration destination setting in advance. When a document is read, the user selects an integration destination for read image data by selecting the settings information. This method is intended for advanced users.

The second method involves creating settings information for receiving a selection of one integration destination from among multiple integration destination candidates for read image data. The user selects the settings information and, either before or after a document is read, selects an integration destination for the read image data from among the multiple integration destination candidates. This method is intended for novice users.

In the related art, a mobile terminal having multiple hierarchical menu items generates a shortcut item in a hierarchy level immediately above the level in which a menu item is located, when the selection frequency of the menu item exceeds a preset threshold value for shortcut generation.

### SUMMARY

The information processing apparatus according to one aspect of the present disclosure includes circuitry to receive a selection of an integration destination for imaging data from among a plurality of integration destination candidates, using settings information that includes imaging settings and an integration destination setting, determine whether a usage frequency of the integration destination meets a predetermined condition, create additional settings information that includes the integration destination specified in the integration destination setting when a usage frequency of the integration destination meets a predetermined condition, and display, on a display, the additional settings information as available.

The image reading apparatus according to another aspect of the present disclosure includes an image sensor and circuitry. The image sensor reads image data from a document in accordance with reading settings to generate imaging data. The circuitry receives a selection of an integration destination for imaging data from among a plurality of integration destination candidates, using settings information that includes reading settings and an integration destination setting, determines whether a usage frequency of the integration destination meets a predetermined condition, creates additional settings information that includes the integration destination specified in the integration destination setting when a usage frequency of the integration destination meets a predetermined condition, and displays, on a display, the additional settings information as available.

The non-transitory recording medium according to still another aspect of the present disclosure stores a plurality of instructions which, when executed by one or more processors, causes the one or more processors to perform a method. The method includes receiving a selection of an integration destination for imaging data from among a plurality of integration destination candidates using settings information including imaging settings and an integration destination setting, determining whether a usage frequency of the integration destination meets a predetermined condition, creating additional settings information that includes the integration destination specified in the integration destination setting when a usage frequency of the integration destination meets a predetermined condition, and displaying, on a display, the additional settings information as available.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a system configuration of a profile creation system;

FIG. 2 is a block diagram illustrating an example of a hardware configuration of a computer;

FIG. 3 is a block diagram illustrating an example of a functional configuration of the profile creation system of FIG. 1;

FIG. 4 is a diagram illustrating an example of a profile edit screen;

FIG. 5 is a sequence diagram illustrating a case where a quick menu profile is used;

FIG. 6 is a sequence diagram illustrating a case where a profile other than the quick menu profile is used;

FIG. 7 is a diagram illustrating an example of a profile list screen;

FIG. 8 is a diagram illustrating an example of an integration-destination-application selection screen;

FIG. 9 is a flowchart of an example of a profile creation determination process;

FIG. 10 is a diagram illustrating an example of a profile creation suggestion screen;

FIG. 11 is a diagram illustrating an example of a profile list screen when a profile is added;

FIG. 12 is a diagram illustrating an example of a profile list screen;

FIG. 13 is a table illustrating an example of the number of selections for each profile;

FIG. 14 is a block diagram illustrating an example of a functional configuration of the profile creation system of FIG. 1; and

FIG. 15 is a block diagram illustrating an example of a hardware configuration of an image reading apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring to the drawings, embodiments of the present disclosure are described below. In this specification and drawings, components having substantially the same functional configurations are denoted by identical or similar reference signs, and redundant descriptions thereof are simplified or omitted.

### Embodiments

An information processing system according to an embodiment uses settings information that includes imaging settings and a setting for an integration destination for imaging data. In the following description, the setting for an integration destination may be referred to as an integration destination setting. In the following description, the information processing system is referred to as a “profile creation system”.

The profile is an example of settings information that includes imaging settings of a peripheral device and an integration destination setting for imaging data. The peripheral device is an electronic device (apparatus) that performs imaging in accordance with the imaging settings of the profile and outputs the imaging data. The peripheral device may be an image reading apparatus such as a scanner, a facsimile machine having an image reading function, or a multifunctional peripheral, product, or printer (MFP) having an image reading function. Further, the peripheral device may be an image-capturing device such as a camera, office equipment having an imaging function, a home appliance having an imaging function, or a facility equipment having an imaging function.

When the peripheral device is a scanner, the imaging settings and the imaging data correspond to the document reading settings and the read image data. When the peripheral device is an image-capturing device, the imaging settings and the imaging data correspond to the image-capturing settings and the captured-image data.

In the integration destination setting for imaging data, an application to be integrated with the imaging data (integration destination application) is specified as the integration destination. The integration destination application is, for example, an application installed on a user terminal or an application providing a cloud service such as cloud storage.

In the following description, a scanner is used as an example of the peripheral device. For example, an application for using a scanner from a user terminal is installed on the user terminal, and is referred to as “scanner software” in the following description. A user of the scanner can use a profile by operating the scanner software.

The profiles that are available to the user include a profile that includes an integration destination application specified in the integration destination setting in advance, and a profile that includes an integration destination setting for receiving a selection of one integration destination application from among multiple integration destination applications that are candidates for an integration destination for read image data.

The profile that includes an integration destination application specified in the integration destination setting in advance is efficient when the same integration destination application is to be selected. However, it is difficult for novice users to create such a profile without hesitation when they start using the scanner. The profile that includes the integration destination setting for receiving a selection of one integration destination application from among the multiple integration destination applications, which are candidates for an integration destination for read image data, facilitates ease of use for novice users. However, when the same integration destination application is to be selected, the destination application is repeatedly selected from among the multiple destination candidates, and operational inefficiency may result.

As described above, it is not easy for novice users to create a profile that includes an integration destination application specified in the integration destination setting. The present embodiment is directed to facilitate the ease of creating a profile that includes an integration destination application specified in the integration destination setting.

According to the present embodiment, a profile that includes an integration destination application frequently used by a user and specified in the integration destination setting is automatically created. This allows novice users to more easily create and use a profile that includes an integration destination application specified in the integration destination setting.

### Overall Configuration

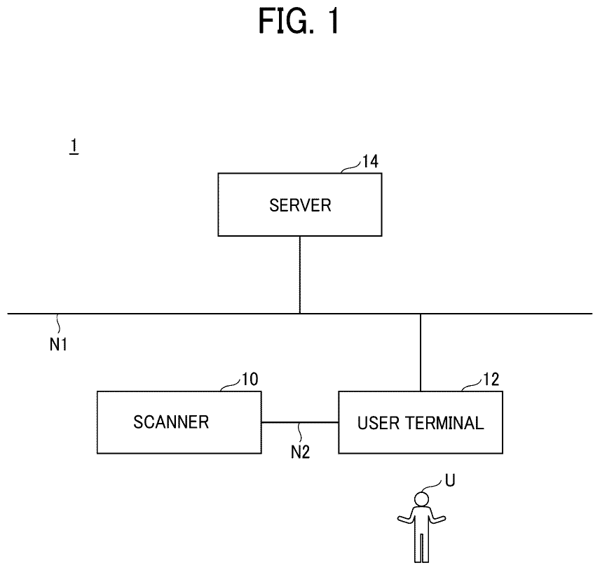

An overall configuration of a profile creation system is described with reference to FIG. 1. FIG. 1 is a diagram illustrating a system configuration of a profile creation system 1.

The profile creation system 1 includes a scanner 10, a user terminal 12, and a server 14. The scanner 10 is an example of a peripheral device. The user terminal 12 is an example of an information processing apparatus.

The user terminal 12 and the server 14 are connected to each other via a communication network N1 for communication. The communication network N1 may be, for example, a local area network (LAN), a virtual private network (VPN), or the Internet.

The scanner 10 and the user terminal 12 are connected to each other via a communication path N2 for communication. The communication path N2 is, for example, a wired or wireless communication network. The communication path N2 may be serial communication using a cable such as a universal serial bus (USB) cable. The communication path N2 may be part of the communication network N1.

The scanner 10 is an example of an image reading apparatus that reads image data from a document in accordance with the document reading settings. The scanner 10 optically reads an image formed on the document and outputs the image as read image data. The scanner 10 transmits the read image data to the user terminal 12 via the communication path N2.

The user terminal 12 is an example of an information processing apparatus such as a personal computer (PC), a smartphone, or a tablet terminal that is operated by a user U. The user terminal 12 is installed with scanner software. The user U can use a profile by operating the scanner software. Further, the user terminal 12 may be installed with one or more integration destination applications.

The server 14 is an example of an information processing apparatus that provides cloud services such as cloud storage. The server 14 may be, for example, a file server. The server 14 is an example of an information processing apparatus such as a server, a workstation, or a personal computer (PC). The server 14 is installed with one or more integration destination applications.

The system configuration of the profile creation system 1 illustrated in FIG. 1 is an example, and the system configuration may vary depending on the intended use or purpose. For example, the profile creation system 1 may include multiple scanners 10 or user terminals 12. For example, the server 14 may be implemented by multiple computers or may be implemented as a cloud computing service.

The divisions of the devices such as the scanner 10, the user terminal 12, and the server 14 illustrated in FIG. 1 are an example. For example, the profile creation system 1 may not include the server 14.

### Hardware Configuration

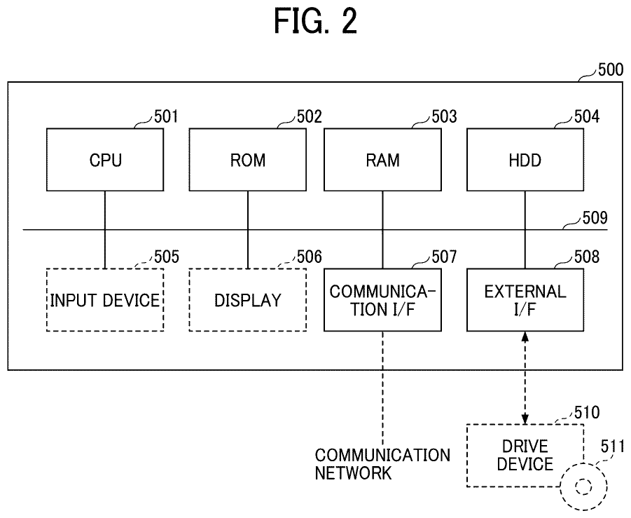

The user terminal 12 and the server 14 may be implemented by, for example, a computer illustrated in FIG. 2. The scanner 10 can be implemented with a configuration that includes the computer illustrated in FIG. 2. FIG. 2 is a block diagram illustrating an example of a hardware configuration of a computer.

As illustrated in FIG. 2, a computer 500 includes a central processing unit (CPU) 501, a read-only memory (ROM) 502, a random-access memory (RAM) 503, a hard disk drive (HDD) 504, an input device 505, a display 506, a communication interface (I/F) 507, and an external I/F 508. The CPU 501, the ROM 502, and the RAM 503 form a so-called computer. The hardware components of the computer 500 are connected to each other via a bus line 509. The input device 505 and the display 506 may be connected via the external I/F 508 rather than directly to the bus line 509, and this may also be used as a form of use.

The CPU 501 reads programs or data from a memory such as the ROM 502 or the HDD 504 into the RAM 503 and executes processing for controlling the computer 500 or implementing a function of the computer 500. The computer 500 may include a graphics processing unit (GPU) in addition to the CPU 501 or instead of the CPU 501.

The ROM 502 is an example of a nonvolatile semiconductor memory (storage device) that retains programs or data even after the power is turned off. The ROM 502 functions as a main memory that stores various programs and data used by the CPU 501 to execute various programs installed on the HDD 504. Specifically, the ROM 502 stores boot programs such as a basic input output system (BIOS) and an external executable firmware interface (EFI) executed at the time of booting the computer 500, and data such as operating system (OS) settings and network settings.

The RAM 503 is an example of a volatile semiconductor memory (storage device) from which programs or data are erased when the power is turned off. The RAM 503 is, for example, a dynamic random-access memory (DRAM) or a static random-access memory (SRAM). The RAM 503 provides a work area for loading various programs installed on the HDD 504 when the programs are executed by the CPU 501.

The HDD 504 is an example of a nonvolatile memory that stores programs or data. The programs or data stored in the HDD 504 include an OS that is basic software for controlling the computer 500 and applications that provide various functions on the OS. The computer 500 may use a memory (for example, a solid-state drive (SSD)) using a flash memory as a storage medium instead of the HDD 504.

The input device 505 is used by a user to input various signals. The input device 505 includes a touch panel, operation keys or buttons, a keyboard, a mouse, and a microphone for inputting sound data such as voice.

The display 506 includes a display such as a liquid crystal display or an organic electro-luminescence (EL) display that displays a screen, and a speaker that outputs sound data such as voice.

The communication I/F 507 is an interface for connecting to a communication network that allows the computer 500 to perform data communication.

The external I/F 508 is an interface that connects the computer 500 to an external device. The external device includes a drive device 510.

The drive device 510 is a device for setting a recording medium 511. Examples of the recording medium 511 include a compact disc-read-only memory (CD-ROM), a flexible disk, and a magneto-optical disc that records data optically, electrically or magnetically. Other examples of the recording medium 511 include a semiconductor memory such as a ROM or a flash memory that electrically records data. The external I/F 508 allows the computer 500 to read or write data from or to the recording medium 511.

For example, the various programs are installed on the HDD 504 by placing the distributed recording medium 511 into the drive device 510 connected to the external I/F 508 and reading the various programs recorded on the recording medium 511 by the drive device 510. The various programs to be installed on the HDD 504 may be installed by being downloaded via the communication I/F 507 through a communication network.

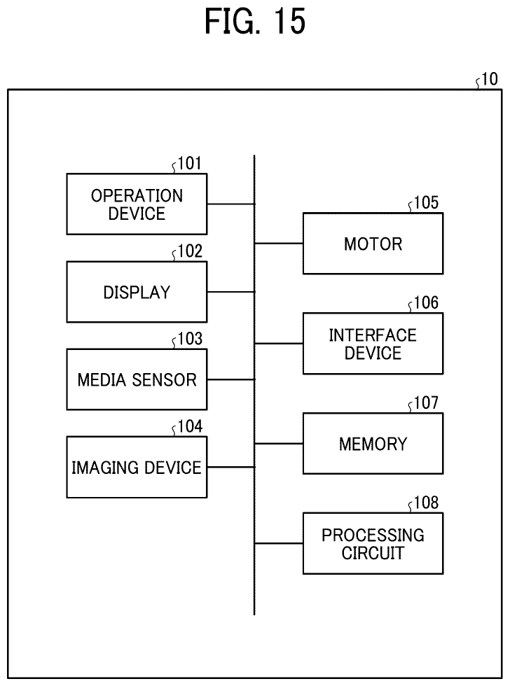

FIG. 15 is a block diagram illustrating an example of a hardware configuration of the scanner 10. As illustrated in FIG. 15, the scanner 10 includes an operation device 101, a display 102, a media sensor 103, an imaging device 104, a motor 105, an interface device 106, a memory 107, and a processing circuit 108.

The operation device 101 includes an input device such as a button and an interface circuit for acquiring signals from the input device, receives input operations from a user, and outputs an operation signal according to the user's input operation.

The display 102 includes a display such as a liquid crystal display or an organic electro-luminescence (EL) display that displays a screen. The operation device 101 and the display 102 may be integrally provided as an operation panel.

The media sensor 103 includes a contact detection sensor and detects whether a medium is placed on the placement table. The media sensor 103 generates and outputs a media signal whose signal value changes depending on whether medium is placed on the placement table or not. The media sensor 103 is not limited to a contact detection sensor, and any other type of sensor capable of detecting the presence or absence of media, such as an optical detection sensor, may be used as the media sensor 103.

The imaging device 104 that includes an imaging sensor captures an image of the medium in the scanner 10. The imaging device 104 includes, for example, a line sensor equipped with an imaging element, a lens that forms an image on the imaging element, and an analog/digital (A/D) converter. Under the control of the processing circuit 108, the imaging device 104 captures (reads) the surface of the medium to generate and output a captured (read) image.

The motor 105 includes one or more motors and, in response to control signals from the processing circuit 108, rotates various rollers within the scanner 10 to convey the media.

The interface device 106 includes an interface circuit conforming to a serial bus such as USB and is electrically connected to the user terminal 12 to transmit and receive input images and various types of information. Alternatively, instead of the interface device 106, a communication unit may be used that includes an antenna for transmitting and receiving wireless signals and a wireless communication interface device for transmitting and receiving signals via a wireless communication line in accordance with a predetermined communication protocol. The predetermined communication protocol may be, for example, a wireless LAN. The communication unit may also include a wired communication interface device for transmitting and receiving signals via a wired communication line in accordance with a communication protocol such as a wired LAN.

The memory 107 includes memories such as a RAM and a ROM, a fixed disk device such as a hard disk, and a portable storage device such as a flexible disk or an optical disk. The memory 107 stores, for example, computer programs, databases, and tables, used for various processes of the scanner 10. The computer program may be installed in the memory 107 from a computer-readable portable recording medium using a known setup program. Examples of the portable recording medium include a CD-ROM and a digital versatile disc read only memory (DVD-ROM).

The processing circuit 108 operates based on a program stored in advance in the memory 107. The processing circuit 108 is, for example, a CPU. As the processing circuit 108, for example, a digital signal processor (DSP), large scale integration (LSI), an application specific integrated circuit (ASIC), a field-programmable gate array (FPGA) may also be used.

### Functional Configuration

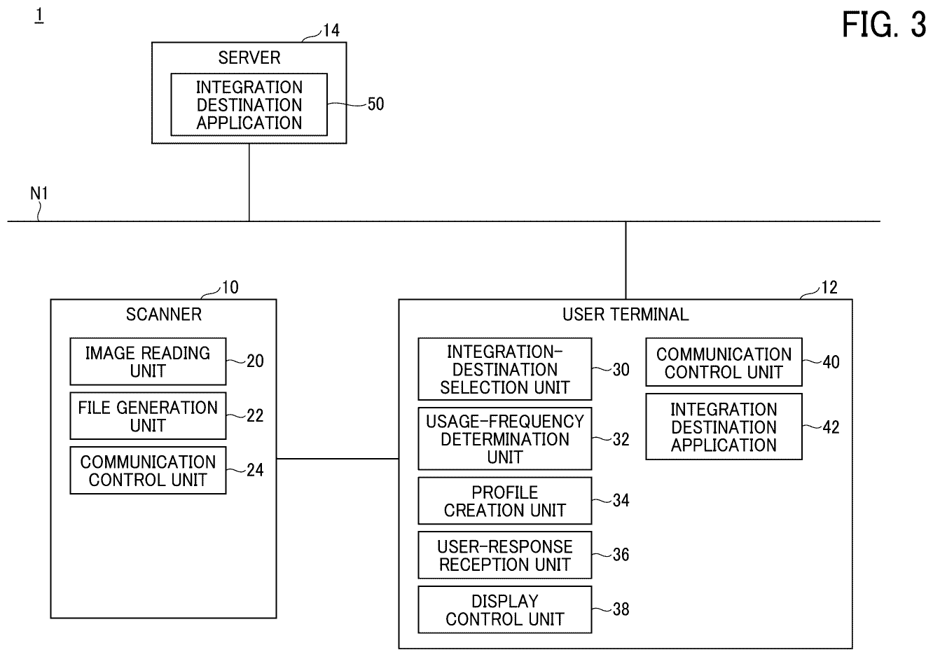

A functional configuration of the profile creation system 1 is described below with reference to FIG. 3. FIG. 3 is a block diagram illustrating an example of a functional configuration of the profile creation system 1.

### Scanner

As illustrated in FIG. 3, the scanner 10 includes an image reading unit 20, a file generation unit 22, and a communication control unit 24. The scanner 10 functions as the image reading unit 20, the file generation unit 22, and the communication control unit 24 by executing an installed scanner program.

The image reading unit 20 starts scanning according to a scan request from the user terminal 12. The image reading unit 20 scans a document in accordance with the document reading settings and optically reads the image formed on the document. The file generation unit 22 generates read image data from the result of document reading performed by the image reading unit 20. The communication control unit 24 receives the scan request from the user terminal 12 and transmits the generated read image data to the user terminal 12.

### User Terminal

As illustrated in FIG. 3, the user terminal 12 includes an integration-destination selection unit 30, a usage-frequency determination unit 32, a profile creation unit 34, a user-response reception unit 36, a display control unit 38, a communication control unit 40, and an integration destination application 42. The user terminal 12 functions as the integration-destination selection unit 30, the usage-frequency determination unit 32, the profile creation unit 34, the user-response reception unit 36, the display control unit 38, the communication control unit 40, and the integration destination application 42 by executing various installed programs. The scanner software is included in a program executed on the user terminal 12.

The integration-destination selection unit 30, the usage-frequency determination unit 32, the profile creation unit 34, the user-response reception unit 36, the display control unit 38, the communication control unit 40, and the integration destination application 42 are implemented by processing executed by the CPU 501 according to a program loaded from the HDD 504 illustrated in FIG. 2 into the RAM 503 illustrated in FIG. 2.

The communication control unit 40 transmits a scan request to the scanner 10 and receives read image data from the scanner 10. Further, when an integration destination application 50 of the server 14 is specified as an integration destination in a profile, the communication control unit 40 transmits the read image data to the integration destination application 50 of the server 14.

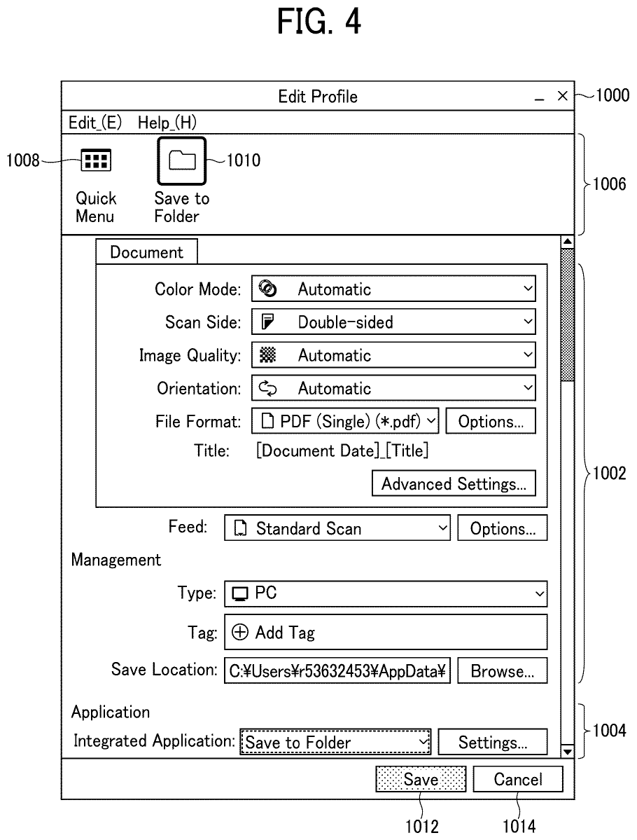

When a profile that includes an integration destination setting for receiving a selection of one integration destination application from among multiple integration destination applications that are candidates for an integration destination for the read image data is used, the integration-destination selection unit 30 receives a selection of an integration destination application. The selection of the integration destination application is performed by the user U. The profile that includes the integration destination setting for receiving a selection of one integration destination application from among multiple destination applications that are candidates for an integration destination for the read image data can be created by the user U using, for example, a profile edit screen 1000 illustrated in FIG. 4.

FIG. 4 is a diagram illustrating an example of the profile edit screen 1000. The profile edit screen 1000 of FIG. 4 includes an input section 1002 for receiving inputs for setting items including document reading settings from the user U, a selection field 1004 for receiving a selection of an integration destination application for read image data from the user U, a profile selection section 1006, a save button 1012, and a cancel button 1014.

The user U can create a profile that specifies an integration destination setting in advance by selecting, for example, “Save to Folder” as an integration destination for read image data in the selection field 1004. The user U can create a profile in which an integration destination is selected each time when scanning is to be performed, by selecting an integration destination, such as “Quick Menu”, in the selection field 1004. In other words, the integration destination setting of the profile allows the user U to select an integration destination from among the multiple integration destination candidates each time when scanning is to be performed.

When the user U performs an operation of pressing the save button 1012, a profile that includes the setting items including the document reading settings entered in the input section 1002 and the integration destination setting for read image data selected in the selection field 1004 is created. When the user U performs an operation of pressing the cancel button 1014, the profile edit screen 1000 closes without creating a profile.

The profile selection section 1006 is a display area where profile select buttons 1008 and 1010 corresponding to created profiles are displayed. In the profile selection section 1006 illustrated in FIG. 4, the profile select button 1008 corresponding to a profile named “Quick Menu” is displayed in a selectable manner. The profile named “Quick Menu” may be referred to as a quick menu profile in the following description. In the profile selection section 1006 illustrated in FIG. 4, the profile select button 1010 corresponding to a profile named “Save to Folder” is displayed in a selectable manner.

For example, in the profile edit screen 1000 illustrated in FIG. 4, the displayed values of the input section 1002 and the selection field 1004 are changed in response to a user operation of the user U selecting the profile select buttons 1008 or 1010 displayed in the profile selection section 1006.

When the profile select button 1008 is selected, the displayed values of the setting items including the document reading settings and the integration destination setting for read image data of the quick menu profile are displayed in the input section 1002 and the selection field 1004. When the profile select button 1010 is selected, the displayed values of the setting items for the document reading settings and the integration destination setting for read image data of the profile named “Save to Folder” are displayed in the input section 1002 and the selection field 1004.

Returning to FIG. 3, the usage-frequency determination unit 32 of the user terminal 12 determines the usage frequency of the integration destination selected by the user U who uses the quick menu profile from the multiple integration destination candidates. The usage-frequency determination unit 32 determines whether the usage frequency of the integration destination selected by the user U from the multiple integration destination candidates meets a predetermined condition.

When determining that the usage frequency of the integration destination is high based on a criterion that is used for determining that a usage frequency is high, the usage-frequency determination unit 32 determines that the usage frequency of the integration destination meets the predetermined condition. The criterion for determining that the usage frequency of an integration destination is high is described in detail later.

The profile creation unit 34 stores the profile that includes the setting items including the document reading settings entered in the input section 1002 and the integration destination setting for read image data selected in the selection field 1004 of the profile edit screen 1000.

Further, when the usage frequency of the integration destination selected by the user U who uses the quick menu profile meets the predetermined condition, the profile creation unit 34 creates a profile that includes the integration destination specified in the integration destination setting.

When the usage frequency of the integration destination selected by the user U who uses the quick menu profile meets the predetermined condition, the profile creation unit 34 may display the options for whether to create a profile that includes the integration destination specified in the integration destination setting to allow the user U to select whether to create the profile. The user-response reception unit 36 receives an operation of the response by the user U, such as the selection of one of the options.

The display control unit 38 controls display of various screens such as the profile edit screen 1000 of FIG. 4. The display control unit 38 controls display of an integration-destination-application selection screen and a profile list screen, which are described later. The integration destination application 42 is an example of an integration destination to be specified in the integration destination setting of a profile.

### Server

The server 14 of FIG. 3 includes the integration destination application 50. The server 14 functions as the integration destination application 50 by executing various installed programs. The integration destination application 50 is an example of an integration destination to be specified in the integration destination setting of a profile. The integration destination application 50 is, for example, a web application. The integration destination application 50 is, for example, a cloud storage service, a communication tool service, a digital notebook creation service, or an information sharing platform.

The functional configuration of the profile creation system 1 illustrated in FIG. 3 is an example, and the functional configuration may vary depending on the intended use or purpose. The divisions of the processing units such as the integration-destination selection unit 30, the usage-frequency determination unit 32, the profile creation unit 34, the user-response reception unit 36, the display control unit 38, the communication control unit 40, and the integration destination application 42 of the user terminal 12 illustrated in FIG. 3 are an example.

### Process

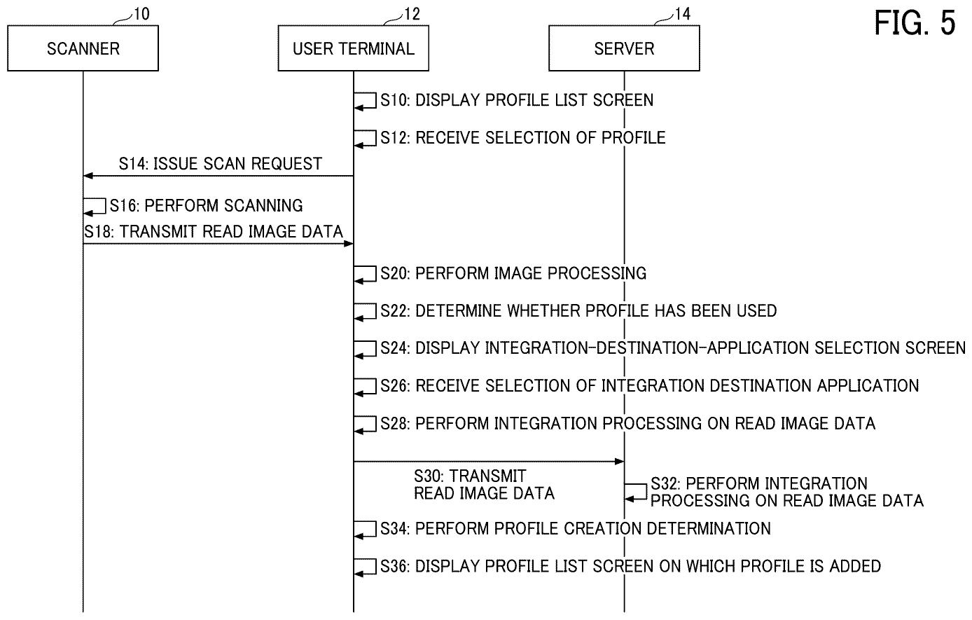

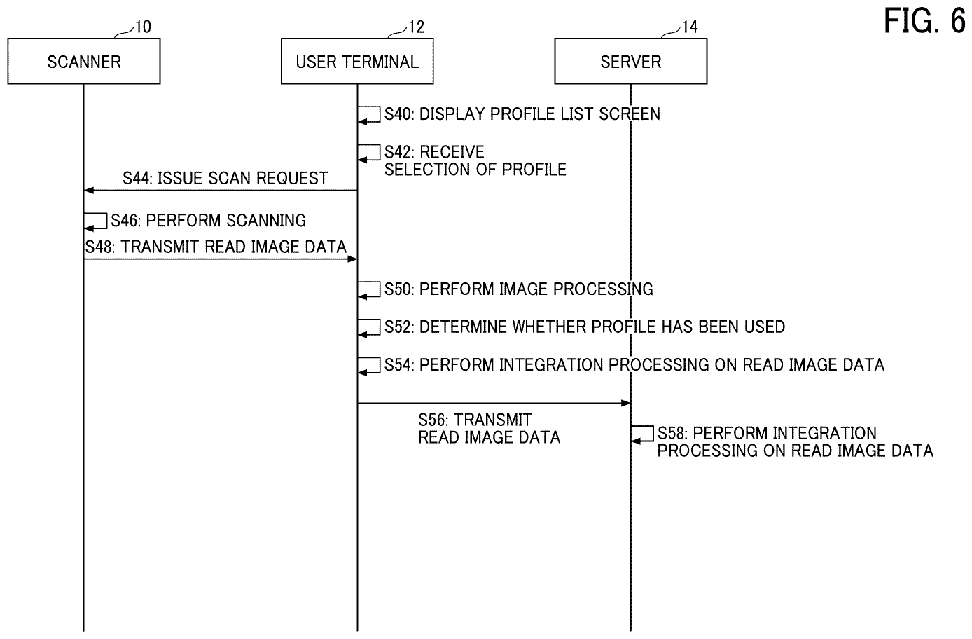

A method for creating a profile executed by the profile creation system 1 is described below with reference to FIGS. 5 and 6. FIG. 5 is a sequence diagram illustrating a case where a quick menu profile is used. FIG. 6 is a sequence diagram illustrating a case where a profile other than the quick menu profile is used.

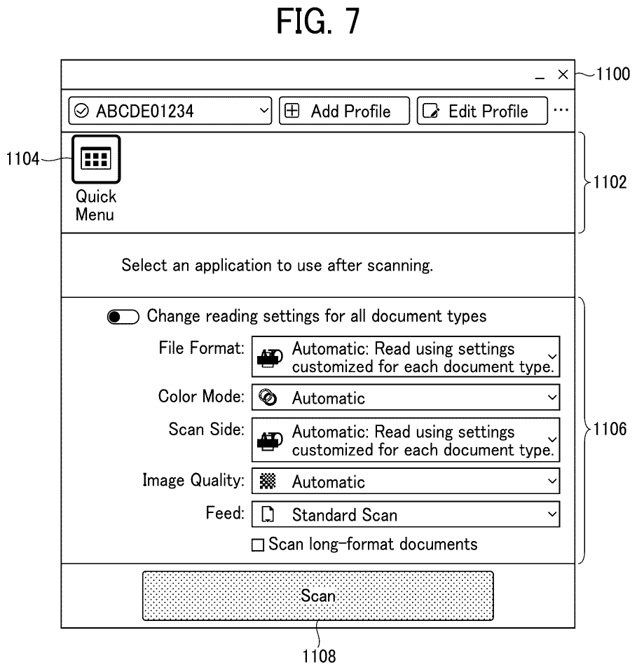

In step S10 of FIG. 5, the display control unit 38 of the user terminal 12 starts the scanner software and displays a profile list screen as illustrated in FIG. 7.

FIG. 7 is a diagram illustrating an example of a profile list screen 1100. The profile list screen 1100 of FIG. 7 includes a profile selection section 1102, an input section 1106 for receiving inputs for document reading settings from the user U, and a scan button 1108.

The profile selection section 1102 is a display area where a profile select button 1104 corresponding to a created quick menu profile is displayed. In the profile selection section 1102 illustrated in FIG. 7, the profile select button 1104 corresponding to the quick menu profile is displayed in a selectable manner. The profile selection section 1102 illustrated in FIG. 7 is an example where no profiles other than the quick menu profile have been created. The scan button 1108 is operable to receive a user input to start scanning. The user input is performed by the user U.

In step S12, the user-response reception unit 36 of the user terminal 12 receives a selection of the quick menu profile in response to a user operation in which the user U presses the profile select button 1104. Further, pressing the scan button 1108 allows the user U to instruct the scanner software of the user terminal 12 to start document scanning.

In step S14, the communication control unit 40 of the user terminal 12 issues a scan request to the scanner 10. In step S16, the image reading unit 20 of the scanner 10 performs document scanning in accordance with the document reading settings of the quick menu profile.

In step S16, the file generation unit 22 generates read image data based on the result of document reading performed by the image reading unit 20. In step S18, the communication control unit 24 transmits the generated read image data to the user terminal 12.

In step S20, the user terminal 12 performs image processing on the read image data received from the scanner 10 as appropriate.

In step S22, the integration-destination selection unit 30 of the user terminal 12 determines whether the quick menu profile has been used. Since FIG. 5 is a sequence diagram illustrating the case where a quick menu profile is used, the integration-destination selection unit 30 determines that a quick menu profile is used.

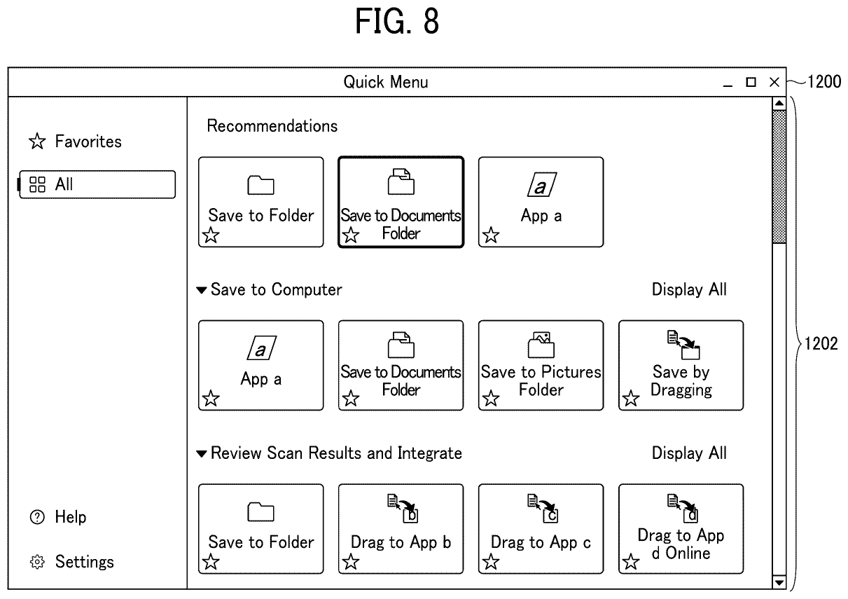

In step S24, the display control unit 38 of the user terminal 12 displays an integration-destination-application selection screen 1200 as illustrated in FIG. 8.

FIG. 8 is a diagram illustrating an example of the integration-destination-application selection screen 1200. The integration-destination-application selection screen 1200 of FIG. 8 includes an integration-destination-application selection section 1202. The integration-destination-application selection section 1202 is a display area in which integration-destination-application select buttons each corresponding to an integration destination application are displayed. In the integration-destination-application selection section 1202 illustrated in FIG. 8, the integration-destination-application select buttons are displayed in a selectable manner.

The integration-destination-application selection section 1202 illustrated in FIG. 8 displays integration-destination select buttons corresponding to integration destination applications such as applications or web applications installed on the user terminal 12.

In step S26, the integration-destination selection unit 30 of the user terminal 12 receives a selection of an integration destination application via the integration-destination-application selection section 1202 of the integration-destination-application selection screen 1200 of FIG. 8. The selection is made by the user U. For example, the user U selects an integration destination application named “Save to Folder” in the integration-destination-application selection section 1202 illustrated in FIG. 8.

When the integration destination application selected in step S26 is the integration destination application 42 of the user terminal 12, the user terminal 12 performs integration processing to integrate the read image data with the integration destination application 42 of the user terminal 12 in step S28.

When the integration destination application selected in step S26 is the integration destination application 50 of the server 14, the communication control unit 40 transmits the read image data to the server 14 in step S30.

In step S32, the server 14 performs integration processing to integrate the read image data with the integration destination application 50 of the server 14 selected in step S26.

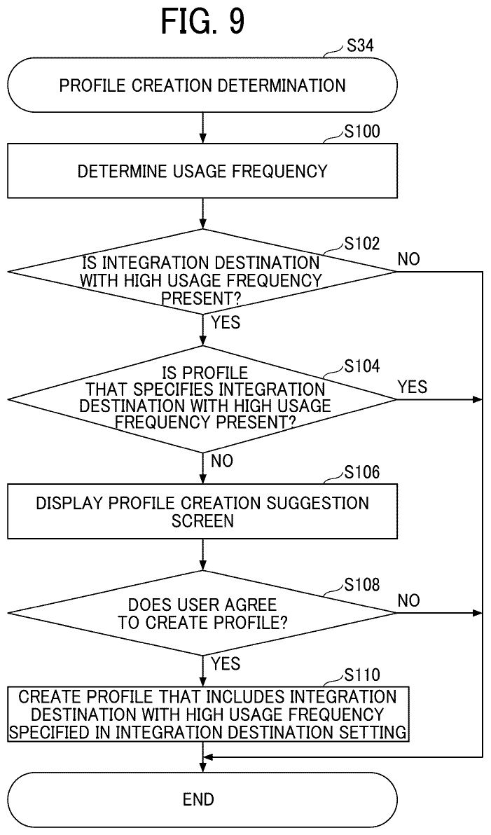

In step S34, the user terminal 12 performs a profile creation determination process in a manner illustrated, for example, in FIG. 9. The profile creation determination process is a process to create a profile that includes the integration destination setting specifying the integration destination application selected in step S26 when the usage frequency of the integration destination application selected in step S26 meets a predetermined condition.

FIG. 9 is a flowchart of a profile creation determination process in step S34.

In step S100, the usage-frequency determination unit 32 of the user terminal 12 determines the usage frequency of the integration destination application selected on the integration-destination-application selection screen 1200 of FIG. 8.

For example, the usage-frequency determination unit 32 determines the usage frequency of the integration destination application based on whether a predetermined condition is met. The usage-frequency determination unit 32 may determine whether the usage frequency of the integration destination application is high based on the criterion for determining that the usage frequency of an integration destination application is high.

For example, the usage-frequency determination unit 32 determines whether the usage frequency of the integration destination application is high based on whether a predetermined condition is met. The predetermined condition is that the same integration destination application is selected for N consecutive times by the user U. When the same integration destination application is selected for N consecutive times by the user U, the usage-frequency determination unit 32 determines that the usage frequency of the integration destination application is high. In this case, the criterion for determining that the usage frequency of the integration destination application is high is that the same integration destination application is selected for N consecutive times by the user U.

Further, the usage-frequency determination unit 32 may determine whether the usage frequency of the integration destination application is high based on whether another predetermined condition is met. The predetermined condition is that the same integration destination application is selected a total of N times by the user U. When the same integration destination application is selected a total of N times by the user U, the usage-frequency determination unit 32 determines that the usage frequency of the integration destination application is high. In this case, the criterion for determining that the usage frequency of the integration destination application is high is that the same integration destination application is selected a total of N times by the user U.

Further, the usage-frequency determination unit 32 may determine whether the usage frequency of the integration destination application is high based on whether still another predetermined condition is met. The predetermined condition is that the same integration destination application is selected for N consecutive days by the user U. When the same integration destination application is selected for N consecutive days by the user U, the usage-frequency determination unit 32 determines that the usage frequency of the integration destination application is high. In this case, the criterion for determining that the usage frequency of the integration destination application is high is that the same integration destination application is selected for N consecutive days by the user U.

Further, the usage-frequency determination unit 32 may determine whether the usage frequency of the integration destination application is high based on whether still another predetermined condition is met. The predetermined condition is that the same integration destination application is selected a total of N days by the user U. When the same integration destination application is selected a total of N days by the user U, the usage-frequency determination unit 32 determines that the usage frequency of the integration destination application is high. In this case, the criterion for determining that the usage frequency of the integration destination application is high is that the same integration destination application is selected over a total of N days by the user U.

Further, the usage-frequency determination unit 32 may determine whether the usage frequency of the integration destination application is high based on whether still another predetermined condition is met. The predetermined condition is that the usage rate is greater than a predetermined threshold. The usage rate for each integration destination application is calculated based on the number of times the integration-destination-application selection screen 1200 of FIG. 8 is passed through and the number of selections of the integration destination application by the user U. When the usage rate calculated based on the number of times the integration-destination-application selection screen 1200 is passed through and the number of selections of the integration destination application by the user U is greater than the predetermined threshold, the usage-frequency determination unit 32 determines that the usage frequency of the integration destination application is high. In this case, the criterion for determining that the usage frequency of the integration destination application is high is that the usage rate calculated based on the number of times the integration-destination-application selection screen 1200 is passed through and the number of selections of the integration destination application by the user U is greater than the predetermined threshold.

Further, when an integration destination application is selected by the user U on the integration-destination-application selection screen 1200 of FIG. 8, the usage-frequency determination unit 32 increases the number of selections of the integration destination application and decreases the number of selections of each unselected integration destination application. The usage-frequency determination unit 32 may determine whether the usage frequency of the integration destination application is high based on whether still another predetermined condition is met. The predetermined condition is that the number of selections is greater than a predetermined threshold. When the number of selections is greater than the predetermined threshold, the usage-frequency determination unit 32 determines that the usage frequency of the integration destination application is high. In this case, the criterion for determining that the usage frequency of the integration destination application is high is that the number of selections of an integration destination application is greater than a predetermined threshold. The number of selections of the integration destination is obtained by increasing the number of selections when the integration destination application is selected and decreasing the number of selections when the integration destination application is not selected.

In step S102, the profile creation unit 34 may determine whether the usage frequency of the integration destination application is high based on the usage frequency of the integration destination application determined in step S100. In other words, in step S102, the profile creation unit 34 determines whether an integration destination application with high usage frequency is present based on the determination on the usage frequency of the integration destination applications made in step S100.

When the profile creation unit 34 determines that the usage frequency of the integration destination application is not high, namely, the integration destination with high usage frequency is not present, in step S102, the process of the flowchart of FIG. 9 ends. When the profile creation unit 34 determines that the usage frequency of the integration destination application is high, namely, the integration destination with high usage frequency is present, in step S102, the profile creation unit 34 proceeds to step S104 to determine whether a profile that specifies the integration destination application with high usage frequency is already present.

When the profile creation unit 34 determines that a profile that specifies the integration destination application with high usage frequency is already present in step S104, the process of the flowchart of FIG. 9 ends. When the profile creation unit 34 determines that the usage frequency of the integration destination application is high, namely, the integration destination with high usage frequency is present, in step S102, the profile creation unit 34 does not create a profile that includes the integration destination application specified in the integration destination setting, or omits creating the profile.

Further, even when the usage frequency of the integration destination application is determined to be high, namely, the integration destination with high usage frequency is determined to be present, and a profile that includes the integration destination application with high usage frequency specified in the integration destination setting is present, the profile creation unit 34 may create a profile that includes the integration destination application specified in the integration destination setting if the setting items including the document reading settings differ.

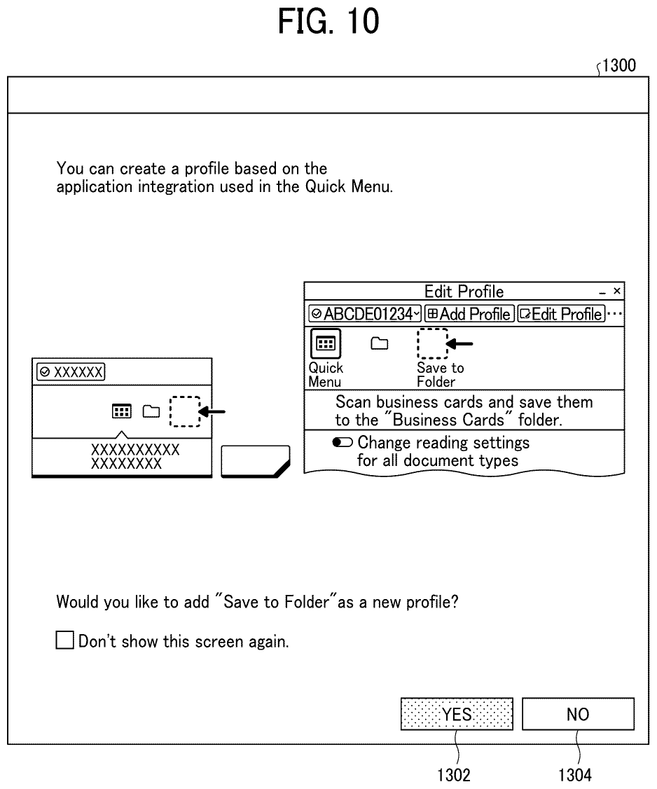

When the profile creation unit 34 determines that a profile that specifies the integration destination application with high usage frequency is not present in step S104, the process proceeds to step S106. In step S106, the display control unit 38 displays a profile creation suggestion screen 1300 as illustrated in FIG. 10.

FIG. 10 is a diagram illustrating an example of the profile creation suggestion screen 1300. The profile creation suggestion screen 1300 of FIG. 10 is an example of a screen that proposes to the user U to create a profile that specifies the integration destination application selected on the integration-destination-application selection screen 1200 in FIG. 8 in using the quick menu profile. The profile creation suggestion screen 1300 includes buttons 1302 and 1304 that are operable by the user U. The button 1302 is operated by the user U when the user U agrees to create a profile, and the button 1304 is operated by the user U when the user U does not agree to create a profile.

In step S108 of FIG. 9, the profile creation unit 34 determines whether the user U agrees to create a profile that includes the integration destination application with high usage frequency specified in the integration destination setting.

When the button 1302 is operated by the user U, namely, the user U agrees to create a profile, the process proceeds to step S110. In step S110, the profile creation unit 34 creates a profile that includes the integration destination application with high usage frequency specified in the integration destination setting. When the button 1034 is operated by the user U, namely, the user U does not agree to create a profile, the process of the flowchart of FIG. 9 ends.

The processing of step S106 may be omitted. When the processing of step S106 is omitted, the profile creation unit 34 automatically creates a profile without requesting approval to create a profile from the user U.

In the following description, it is assumed that the profile has been created in step S110. The explanation continues with reference to FIG. 5.

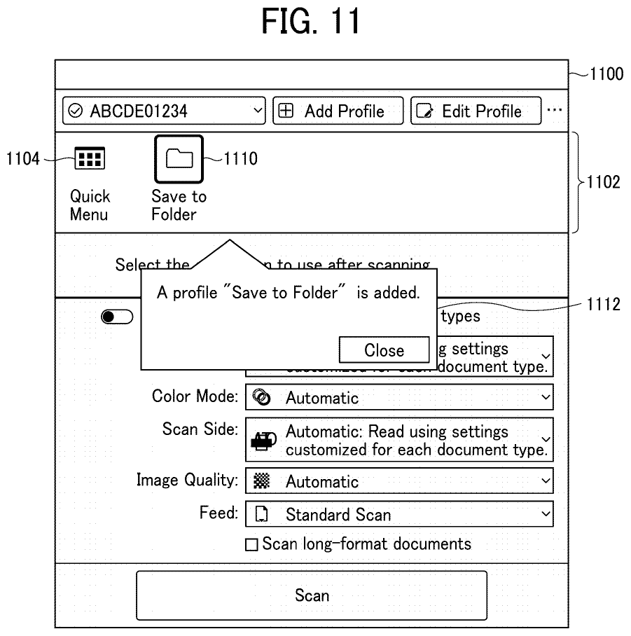

Following step S34 of FIG. 5, the process proceeds to step S36. In step S36, the display control unit 38 displays the profile list screen 1100 of FIG. 11. The profile list screen 1100 of FIG. 11 is substantially the same as FIG. 7, with the addition of a profile select button 1110 corresponding to the profile created in step S110.

FIG. 11 is a diagram illustrating an example of the profile list screen 1100 when a profile is added. The profile list screen 1100 of FIG. 11 displays the profile select button 1110 corresponding to the added profile, in a selectable manner in the profile selection section 1102. Further, the profile list screen 1100 of FIG. 11 displays a message 1112 for notifying the user U that a new profile has been added.

The profile list screen 1100 of FIG. 11 is an example of a screen that additionally displays a button corresponding to a profile created when the usage frequency of the integration destination application selected during the use of the quick menu profile meets a predetermined condition.

The case where one other than the quick menu profile is selected on the profile list screen 1100 of FIG. 11 to be used is described below with reference to FIG. 6.

In step S40 of FIG. 6, the display control unit 38 of the user terminal 12 starts the scanner software and displays the profile list screen 1100 of FIG. 11. The message 1112 on the profile list screen 1100 of FIG. 11 may be displayed for a certain period of time from the creation of the profile, or until the number of displays reaches a predetermined count. The message 1112 allows the user U to recognize that a new profile has been added, thereby promoting the user U to use the profile. The content of the message 1112 is an example and may explain the benefits of using the profile.

In step S42, the user-response reception unit 36 of the user terminal 12 receives a selection of the profile that is named “Save to Folder” in response to a user operation in which the user U presses the profile select button 1110. Further, the user U can instruct the scanner software of the user terminal 12 to start document scanning by pressing the scan button.

In step S44, the communication control unit 40 of the user terminal 12 issues a scan request to the scanner 10. In step S46, the image reading unit 20 of the scanner 10 performs document scanning in accordance with the document reading settings of the profile selected in step S42.

In step S46, the file generation unit 22 generates read image data based on the result of document reading performed by the image reading unit 20. In step S48, the communication control unit 24 transmits the generated read image data to the user terminal 12.

In step S50, the user terminal 12 performs image processing on the read image data received from the scanner 10 as appropriate. In step S52, the integration-destination selection unit 30 of the user terminal 12 determines whether the quick menu profile has been used. Since FIG. 6 is a sequence diagram illustrating the case where a quick menu profile is not used, the integration-destination selection unit 30 determines that a quick menu profile is not used.

When the integration destination application of (specified in) the selected profile selected in step S42 is the integration destination application 42 of the user terminal 12, the user terminal 12 performs the processing of step S54. In step S54, the user terminal 12 performs integration processing to integrate the read image data with the integration destination application 42 of the user terminal 12.

When the integration destination application of (specified in) the profile selected in step S42 is the integration destination application 50 of the server 14, the communication control unit 40 transmits the read image data to the server 14 in step S56.

In step S58, the server 14 performs integration processing to integrate the read image data with the integration destination application 50 of the server 14 of the profile selected in step S42.

### Modification

In the above-described embodiment, the usage frequency of the integration destination application determined in step S100 is used to determine whether to display the profile creation suggestion screen 1300 of FIG. 10. Additionally, the proficiency of the user U regarding profiles may also be used to determine whether to display the profile creation suggestion screen 1300. Further, the proficiency of the user U regarding profiles may be determined to be low based on a criterion that is used for determining that the proficiency of the user U regarding profiles is low.

For example, the criterion for determining that the proficiency of the user U regarding profiles is low is that the profile remains in its default state. Further, for example, the criterion for determining that the proficiency of the user U regarding profiles is low is that the number of selections of a profile is equal to or less than a predetermined number or that the number of setting changes is small, for example, less than one. The predetermined number may be set by a designer. Further, for example, the criterion for determining that the proficiency of the user U regarding profiles is low is that the time required to complete the configuration is long, for example, twice as long as the average time among users.

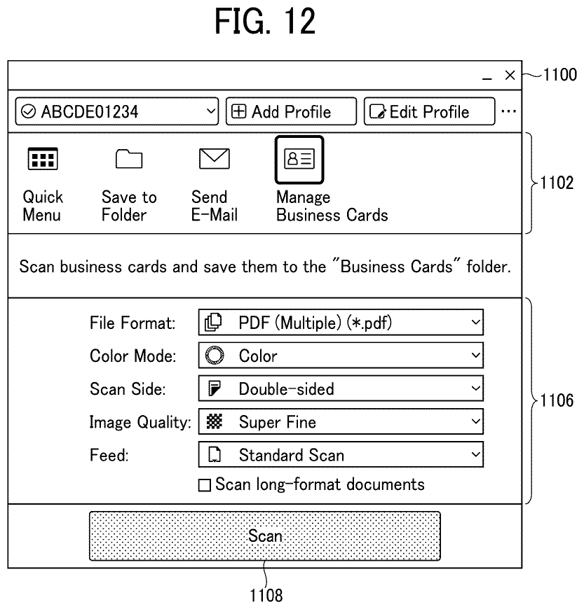

FIG. 12 is a diagram illustrating an example of the profile list screen 1100. The profile selection section 1102 of the profile list screen 1100 of FIG. 12 is a display area where a select button corresponding to a quick menu profile and three select buttons corresponding to profiles other than the quick menu profile are displayed.

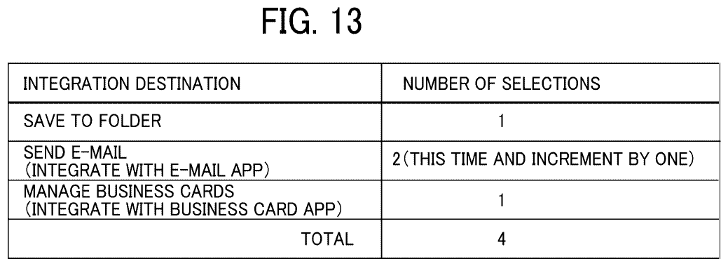

For example, in the case of the profile selection section 1102 illustrated in FIG. 12, the number of selections for each profile other than the quick menu profile is counted as illustrated in FIG. 13, and when the total number of selections is equal to or less than a predetermined number, it is determined that the proficiency of the user U regarding profiles is low.

In the above-described embodiment, creating a profile is suggested to the user U by displaying the profile creation suggestion screen 1300 of FIG. 10, and when the approval of the user U is obtained, a profile is automatically created. The display control unit 38 may display the steps for creating a profile, instead of automatically creating a profile, and recommend the creation of a profile by the user U.

In the above-described embodiment, when it is determined that a profile that specifies the integration destination application with high usage frequency is already present in step S104, using the profile that is already present may be recommended, instead of creating a profile that includes the integration destination application specified in the integration destination setting.

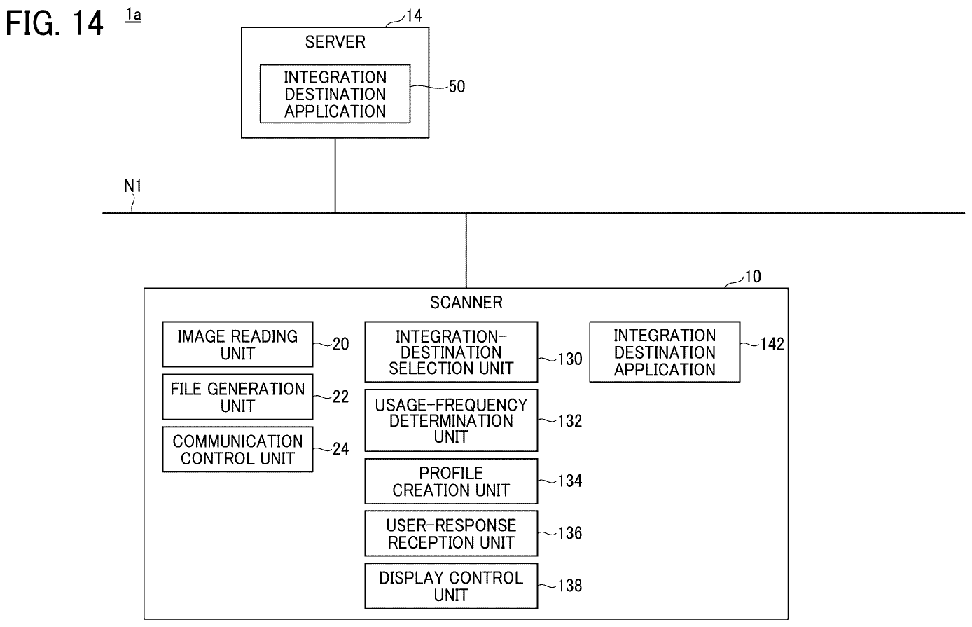

A profile creation system 1a illustrated in FIG. 14 includes the scanner 10 that includes the integration-destination selection unit 30, the usage-frequency determination unit 32, the profile creation unit 34, the user-response reception unit 36, the display control unit 38, and the integration destination application 42.

FIG. 14 is a block diagram illustrating an example of a functional configuration of the profile creation system 1a.

FIG. 14 is substantially the same as the profile creation system 1 of FIG. 3, except for a portion, and detailed descriptions are omitted as appropriate. As illustrated in FIG. 14, the scanner 10 includes an integration-destination selection unit 130, a usage-frequency determination unit 132, a profile creation unit 134, a user-response reception unit 136, a display control unit 138, and an integration destination application 142, in addition to the image reading unit 20, the file generation unit 22, and the communication control unit 24.

When a profile that includes an integration destination setting for receiving a selection of one integration destination application from among multiple integration destination applications that are candidates for integration destinations of read image data is used, the integration-destination selection unit 130 receives a selection of an integration destination application. The selection of the integration destination application is performed by the user U.

The usage-frequency determination unit 132 determines the usage frequency of the integration destination selected from among the multiple integration destination candidates by the user U who uses the quick menu profile.

The profile creation unit 134 stores a profile that includes the setting items including the document reading settings entered in the input section 1002 and the integration destination setting for read image data selected in the selection field 1004 of the profile edit screen 1000. The user-response reception unit 136 receives an operation of the response by the user U, such as the selection of one of the options.

The display control unit 138 controls display of various screens such as the profile edit screen 1000 of FIG. 4. The display control unit 138 controls display of the integration-destination-application selection screen 1200 and the profile list screen 1100. The integration destination application 142 is an example of an integration destination to be specified in the integration destination setting of a profile. The integration destination application 142 may be included in the user terminal 12.

According to the present embodiment, when an integration destination application frequently used by the user U who uses the quick menu profile is present, a profile that includes the integration destination application specified in the integration-destination setting can be automatically created and provided to the user U. The user U can more easily create a profile that includes an integration destination application with high usage frequency, specified in the integration-destination setting. Further, according to the present embodiment, the use of a profile that includes an integration destination application frequently used by the user U and specified in the integration destination setting can be facilitated.

In the related art, a user selects an integration destination for image data read from a document by a scanner by the following two methods using settings information (such as a profile) that includes document reading settings and a setting for an integration destination for read image data. In the following description, the setting for an integration destination may be referred to as an integration destination setting.

The first method involves creating settings information that includes an integration destination application specified in the integration destination setting in advance. When a document is read, the user selects an integration destination for read image data by selecting the settings information. This method is intended for advanced users.

The second method involves creating settings information for receiving a selection of one integration destination from among multiple integration destination candidates for read image data. The user selects the settings information and, either before or after a document is read, selects an integration destination for the read image data from among the multiple integration destination candidates. This method is intended for novice users.

Regarding the first method, it is difficult for novice users to create, in advance, settings information that includes an integration destination application specified in the integration destination setting. As described above, it is not easy for novice users to create settings information that includes an integration destination specified in the integration destination setting. In the second method, when the same integration destination is repeatedly selected from among multiple integration destination candidates for read image data, operational inefficiency may result.

According to an aspect of the present disclosure, settings information that includes an integration destination specified in the integration destination setting can be created more easily.

Each of the above-described functions may be implemented by one or more pieces of processing circuitry. The “processing circuitry” in the present disclosure includes a programmed processor to execute each function by software, such as a processor implemented by an electronic circuit, and a device such as an application-specific integrated circuit (ASIC), a digital signal processor (DSP), a field-programmable gate array (FPGA), and other circuit modules arranged to perform the functions of the above-described embodiments.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above. The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or digital versatile disc (DVD), and/or the memory of an FPGA or ASIC.

1. An information processing apparatus, comprising circuitry configured to:
receive a selection of an integration destination for imaging data from among a plurality of integration destination candidates, using settings information that includes imaging settings and an integration destination setting;
determine whether a usage frequency of the integration destination meets a predetermined condition;
create additional settings information that includes the integration destination specified in the integration destination setting when the usage frequency of the integration destination meets the predetermined condition; and
display, on a display, the additional settings information as available.

2. The information processing apparatus of claim 1, wherein,
when the usage frequency of the integration destination meets the predetermined condition, the circuitry is further configured to:
display, on the display, options for whether to create the additional settings information; and
receive a selection of one of the options.

3. The information processing apparatus of claim 1,
wherein, when the usage frequency of the integration destination meets the predetermined condition, the circuitry is further configured to determine whether the additional settings information that includes the integration destination specified in the integration destination setting is already present, and
wherein, when the additional settings information that includes the integration destination specified in the integration destination setting is not present, the circuitry creates the additional settings information.

4. The information processing apparatus of claim 3, wherein,
when the additional settings information that includes the integration destination specified in the integration destination setting is already present and the imaging settings differ, the circuitry creates the additional settings information that includes the integration destination specified in the integration destination setting.

5. The information processing apparatus of claim 1, wherein,
when the usage frequency of the integration destination meets the predetermined condition, the circuitry is further configured to determine whether proficiency of a user regarding the settings information is low based on a criterion for determining that the proficiency of the user regarding the settings information is low, and
when the proficiency of the user regarding the settings information is determined to be low, the circuitry is configured to create the additional settings information.

6. The information processing apparatus of claim 1, wherein,
when the usage frequency of the integration destination meets the predetermined condition, the circuitry is further configured to:
recommend creating the additional settings information that includes the integration destination specified in the integration destination setting, and
create the additional settings information that includes the integration destination specified in the integration destination setting when the recommendation is approved.

7. The information processing apparatus of claim 1,
wherein, when the usage frequency of the integration destination meets the predetermined condition, the circuitry is further configured to determine whether the additional settings information that includes the integration destination specified in the integration destination setting is already present, and
wherein, when the additional settings information that includes the integration destination specified in the integration destination setting is already present, the circuitry is further configured to recommend use of the additional settings information.

8. The information processing apparatus of claim 1, wherein,
when the usage frequency of the integration destination is determined to be high based on a criterion for determining that the usage frequency of the integration destination is high, the circuitry is configured to determine that the usage frequency of the integration destination meets the predetermined condition.

9. An image reading apparatus, comprising:
an image sensor to read image data from a document in accordance with reading settings to generate imaging data; and
circuitry configured to
receive a selection of an integration destination for the imaging data from among a plurality of integration destination candidates, using settings information that includes reading settings and an integration destination setting;
determine whether a usage frequency of the integration destination meets a predetermined condition;
create additional settings information that includes the integration destination specified in the integration destination setting when the usage frequency of the integration destination meets the predetermined condition; and
display, on a display, the additional settings information as available

10. The image reading apparatus of claim 9, wherein,
when the usage frequency of the integration destination meets the predetermined condition, the circuitry is further configured to:
display, on the display, options for whether to create the additional settings information; and
receive a selection of one of the options.

11. The image reading apparatus of claim 9,
wherein, when the usage frequency of the integration destination meets the predetermined condition, the circuitry is further configured to determine whether the additional settings information that includes the integration destination specified in the integration destination setting is already present, and
wherein, when the additional settings information that includes the integration destination specified in the integration destination setting is not present, the circuitry creates the additional settings information.

12. The image reading apparatus of claim 10, wherein,
when the additional settings information that includes the integration destination specified in the integration destination setting is already present and the reading settings differ, the circuitry creates the additional settings information that includes the integration destination specified in the integration destination setting.

13. The image reading apparatus of claim 9, wherein,
when the usage frequency of the integration destination meets the predetermined condition, the circuitry is further configured to determine whether proficiency of a user regarding the settings information is low based on a criterion for determining that the proficiency of the user regarding the settings information is low, and
when the proficiency of the user regarding the settings information is determined to be low, the circuitry is configured to create the additional settings information.

14. The image reading apparatus of claim 9, wherein,
when the usage frequency of the integration destination meets the predetermined condition, the circuitry is further configured to:
recommend creating the additional settings information that includes the integration destination specified in the integration destination setting, and
create the additional settings information that includes the integration destination specified in the integration destination setting when the recommendation is approved.

15. The image reading apparatus of claim 9,
wherein, when the usage frequency of the integration destination meets the predetermined condition, the circuitry is further configured to determine whether the additional settings information that includes the integration destination specified in the integration destination setting is already present, and
wherein, when the additional settings information that includes the integration destination specified in the integration destination setting is already present, the circuitry is further configured to recommend use of the additional settings information.

16. The image reading apparatus of claim 9, wherein,
when the usage frequency of the integration destination is determined to be high based on a criterion for determining that the usage frequency of the integration destination is high, the circuitry is configured to determine that the usage frequency of the integration destination meets the predetermined condition.

17. A non-transitory recording medium storing a plurality of instructions which, when executed by one or more processors, causes the one or more processors to perform a method, the method comprising:
receiving a selection of an integration destination for imaging data from among a plurality of integration destination candidates using settings information including imaging settings and an integration destination setting;
determining whether a usage frequency of the integration destination meets a predetermined condition;
creating additional settings information that includes the integration destination specified in the integration destination setting when a usage frequency of the integration destination meets a predetermined condition; and
displaying, on a display, the additional settings information as available.
